(19) United States
(12) Patent Application Publication
(10) Pub. No.: US 2025/0147772 A1
(43) Pub. Date: May 8, 2025

(54) MICROCONTROLLER UNIT, METHOD, AND COMPUTER PROGRAM FOR CHANGING APPLICATIONS

(71) Applicant: Hyundai AutoEver Corp., Seoul (KR)

(72) Inventor: Jae Hyun LIM, Seoul (KR)

(21) Appl. No.: 18/937,943

(22) Filed: Nov. 5, 2024

(30) Foreign Application Priority Data
Nov. 8, 2023 (KR) 10-2023-0153690

(51) Int. Cl. G06F 9/4401

(52) U.S. Cl. CPC G06F 9/4401

(57) ABSTRACT

Devices and methods for changing applications in a microcontroller unit (MCU) are described. According to one embodiment, an MCU comprises a flash memory with a single partition comprising a first memory area for a boot manager, a second memory area for a first application, and a third memory area for a second application. The MCU also comprises a random access memory (RAM), where the boot manager is loaded, and a central processing unit (CPU) to lock interrupts for preventing an occurrence of Read-While-Write (RWW) for the flash memory when performing a re-programming for the second application while executing codes of the first application, to unlock the interrupts after the re-programming has been completed, and to cause the boot manager to activate the second application having a higher priority value when the MCU boots up, by recording the higher priority value for the second application.

### CROSS REFERENCE TO RELATED APPLICATION

This application claims the benefit of and priority to Korea Patent Application No. 10-2023-0153690, filed on Nov. 8, 2023, the entire disclosure of which is hereby incorporated herein by reference in its entirety.

### FIELD OF TECHNOLOGY

The present disclosure relates to technology for re-programming applications of a microcontroller unit (MCU).

### BACKGROUND

Updating a microcontroller unit (MCU) is a process of changing firmware or software of a microcontroller embedded in an electronic apparatus of a vehicle into a new version thereof. Updating is performed for various purposes, such as performance improvement of a vehicle, bug fixes, security enhancement, etc. Since modern vehicles are full of various sensors and actuators and MCUs with connection functions, software updating regularly or when required is essential. One of techniques for updating an MCU is the Over-The-Air (OTA) technique.

The OTA technique refers to a technique for remotely updating software of a device through wireless communication. This technique is widely used particularly in various connected devices such as smartphones, tablet PCs, smartwatches, vehicles, devices for Internet of Things (IoT). Through this technique, a user may download the latest version of software or firmware and install the same without any physical operations.

Before the OTA technique, when updating for a vehicle is required, a user visits a repair shop and has a diagnostor connected to an On-Board Diagnostics (OBD) terminal to proceed with re-programming through diagnosis communication. This process is made by communication between a diagnostor and a target Engine Control Unit (ECU) through a gateway.

Introduction of the OTA technique made the concept of partitions important. A memory was used without partitions in previous times, whereas a memory is used being divided into partitions in these days. The reason why the partitions are important is that a read operation and a write operation cannot be executed simultaneously in a same partition. In order to prevent problems occurring in a flash memory due to this reason, the Read While Write (RWW) is avoided using a random access memory (RAM). Semiconductor companies now make and use MCUs equipped with a flash memory having two physical partitions. In this way, an application and a flash bootloader (FBL) may be simultaneously flashed and, even when interrupts occur in an application, this would not affect operations in other partitions. This may be referred to as a memory redundancy method.

In order to apply the OTA technique, developers divide a flash memory into at least two partitions. When a flash memory is divided into two main partitions, while a system currently in execution is maintained in one partition, a new version of software or firmware may be downloaded and installed in another partition. In this way, basic functions of an apparatus do not need to be stopped during updating. In addition, even when any problems are found in a newly updated version of software or firmware, the software or firmware may easily be rolled back using a partition including a previous stable version of software or firmware. This may provide stability and reliability to users. However, in order to divide a flash memory into at least two partitions, a high specification is required. For this reason, it is difficult to apply real-time updating techniques such as the OTA technique to low-price MCUs.

The discussions in this section are intended merely to provide background information and do not constitute an admission of prior art.

### SUMMARY

In an aspect, the present disclosure is intended to provide a technique of updating applications using a flash memory with a single partition. In another aspect, the present disclosure is intended to provide a technique of rolling back an application, which has been updated or is being updated, using a flash memory with a single partition.

According to an embodiment of the present disclosure, a microcontroller unit is provided. The microcontroller unit comprises: a flash memory with a single partition comprising a first memory area for a boot manager, a second memory area for a first application, and a third memory area for a second application; a random access memory (RAM) where the boot manager is loaded; and a central processing unit (CPU) to lock interrupts for preventing occurrence of Read-While-Write (RWW) for the flash memory when performing a re-programming for the second application while executing codes of the first application, to unlock the interrupts after the re-programming has been completed, and to cause the boot manager to activate the second application having a higher priority value when the MCU boots up, by recording a higher priority value for the second application.

The CPU may lock the interrupts for preventing occurrence of the RWW before recording a higher priority value for the second application.

The CPU may conduct an integrity check for the second application, for which the re-programming has been completed, before recording a higher priority value for the second application and, when the second application is determined to be normal in the integrity check, the CPU may record a higher priority value for the second application.

When locking the interrupts, the CPU may transmit, to a superior application through communication, a signal indicating that the interrupts are locked.

When locking the interrupts, the CPU may inactivate a watchdog function.

Through the boot manager, the CPU may read priority values in predetermined locations of the first application and the second application and compare them to activate one application having a higher priority value.

When a priority value of one application is determined to be invalid, the CPU may activate the other application.

A priority value of each application may have a size smaller than or equal to the size of a page unit.

Each application may store a plurality of priority value variables, and the CPU may sequentially record priority values in variables in which priority values have not been recorded.

The CPU may scan the plurality of priority value variables and determine the highest priority value as a priority value of the relevant application.

According to an embodiment of the present disclosure, a microcontroller unit is provided. The microcontroller unit comprises: a flash memory with a single partition comprising a first memory area for a boot manager, a second memory area for a first application, and a third memory area for a second application; a random access memory (RAM) where the boot manager is loaded; and a central processing unit (CPU) to verify a priority value for the first application when a roll-back to the second application is requested while executing codes of the first application, to lock interrupts for preventing occurrence of Read-While-Write (RWW) for the flash memory, to record a priority value for the second application to be higher than the priority value for the first application, to unlock the interrupts, and to cause the boot manager to activate the second application having a higher priority value when the MCU boots up.

The flash memory may be erased by block and may be written by page. A priority value of each application may have a size smaller than or equal to the size of a page unit.

Each application may store a plurality of priority value variables, and the CPU may sequentially record priority values in variables in which priority values have not been recorded.

The CPU may scan the plurality of priority value variables and determine the highest priority value as a priority value of the relevant application.

When locking the interrupts, the CPU may transmit, to a superior application through communication, a signal indicating that the interrupts are locked.

When locking the interrupts, the CPU may inactivate a watchdog function.

According to an embodiment of the present disclosure, a method for changing applications in a microcontroller unit (MCU) is provided. The method includes operations or steps of: loading a boot manager located in a first memory area of a flash memory with a single partition to execute the boot manager; verifying, by the boot manager, priority values in predetermined locations of a first application in a second memory area of the flash memory and a second application in a third memory area of the flash memory; comparing, by the boot manager, a priority value of the first application and a priority value of the second application to activate one application having a higher priority value; locking interrupts for preventing occurrence of Read-While-Write (RWW) for the flash memory while the first application is executed and unlocking the interrupts after having recorded the priority value of the second application to be higher than the priority value of the first application; and activating, by the boot manager, the second application having a higher priority value when the MCU boots up.

The method may further include an operation or step of locking the interrupts before the operation or step of recording a priority value of the second application to be higher and subsequently unlocking the interrupts after a re-programming for the second application has been completed.

The method may further include, an operation or step of requesting a roll-back to the second application before the operation or step of recording a priority value of the second application to be higher.

According to an embodiment of the present disclosure, a computer program stored in a medium is provided. The computer program stored in a medium is for executing operations or steps of: loading a boot manager located in a first memory area of a flash memory with a single partition to execute the boot manager; verifying priority values in predetermined locations of a first application in a second memory area of the flash memory and a second application in a third memory area of the flash memory; comparing a priority value of the first application and a priority value of the second application to activate one application having a higher priority value; locking interrupts for preventing occurrence of Read-While-Write (RWW) for the flash memory while the first application is executed and unlocking the interrupts after having recorded the priority value of the second application to be higher than the priority value of the first application; and activating the second application having a higher priority value when a system boots up.

As described above, according to embodiments of the present disclosure, an application may be updated using a flash memory with a single partition and an application, which has been updated or is being updated, may be rolled back using a flash memory with a single partition.

### BRIEF DESCRIPTION OF THE DRAWINGS

In order that the disclosure may be well understood, there are now described various forms thereof, given by way of example, reference being made to the accompanying drawings, in which:

FIG. 1 is a diagram illustrating that an MCU according to an embodiment controls an electronic apparatus by communicating with a superior application;

FIG. 2 is a configuration diagram of an MCU according to an embodiment;

FIG. 3 is a diagram illustrating that occurrence of RWW in a flash memory is prohibited;

FIG. 4 is a diagram illustrating area divisions of a flash memory according to an embodiment;

FIG. 5 is a configuration diagram of a header of a first application according to an embodiment;

FIG. 6 is a flow diagram illustrating a method of activating applications based on priority values by an MCU according to an embodiment;

FIG. 7 is a flow diagram illustrating a method of re-programming applications by an MCU according to an embodiment; and

FIG. 8 is a flow diagram illustrating a method of rolling back an application by an MCU according to an embodiment.

### DETAILED DESCRIPTION

Hereinafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order to not obscure the gist of the present disclosure.

In addition, terms such as “1st”, “2nd”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

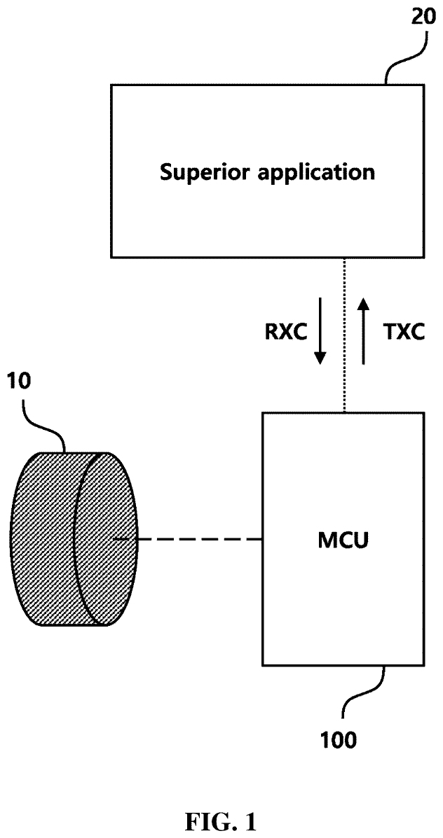

FIG. 1 is a diagram illustrating that an MCU according to an embodiment controls an electronic apparatus by communicating with a superior application.

Referring to FIG. 1, an MCU 100 may control an electronic apparatus 10 or generate measurement values using the electronic apparatus 10.

The MCU 100 may control a motor as an example of the electronic apparatus 10. The MCU 100 may perform a Pulse Width Modulation (PWM) control with respect to the speed of the motor. The MCU 100 may control a sensor as another example of the electronic apparatus 10 to generate measurement values. The MCU 100 may receive an analog signal from the sensor and convert the signal into a digital value using an Analog to Digital Converter (ADC). The MCU 100 may further a module, such as a General Purpose Input/Output (GPIO) pin, Pulse-Width Modulation (PWM), Analog to Digital Converter (ADC) or the like, in order to control such an electronic apparatus 10.

The MCU 100 may communicate with various external devices such as a display, network interface, etc. to control the electronic apparatus 10. In particular, the MCU 100 may communicate with a superior application 20 to control the electronic apparatus 10.

The superior application 20 may be a user interface or a device to perform complicated processing operations. The MCU 100 may transmit and receive data TXC, RXC with the superior application using various communication protocols such as a Serial Peripheral Interface (SPI), Inter-Integrated Circuit (I2C), Controller Area Network (CAN), etc.

Since the MCU 100 controls the electronic apparatus 10 in real time, the MCU 100 may react and complete operations within a given time. For this, the MCU 100 may utilize an interrupt system to react to events in real time.

For example, supposing that the electronic apparatus 10 is a direct current (DC) motor and the MCU 100 is a device to control the DC motor, the superior application 20 may set up the location of the DC motor through the MCU 100. The MCU 100 may control the speed and direction of the motor by connecting a PWM output to a motor driver. The MCU 100 may be connected with the superior application 20 through a communication interface such as a CAN. In this circumstance, when the superior application 20 recognizes user's operations and tries to change the location of the DC motor, the superior application 20 may transmit a command indicating the change of location of the DC motor to the MCU 100. A communication port of the MCU 100 may detect the arrival of new data and process the arrival of new data as an interrupt. When an interrupt occurs as such, the MCU 100 may stop an operation in execution, analyze the data received through the communication port, and change the location of the DC motor. Then, the MCU 100 may transmit a message indicating that the location change of the DC motor is completed to the superior application 20 through the communication port.

As described above, the MCU 100 may react in real time to required operations using an interrupt system. The MCU 100 may also react in real time to a watchdog circuit.

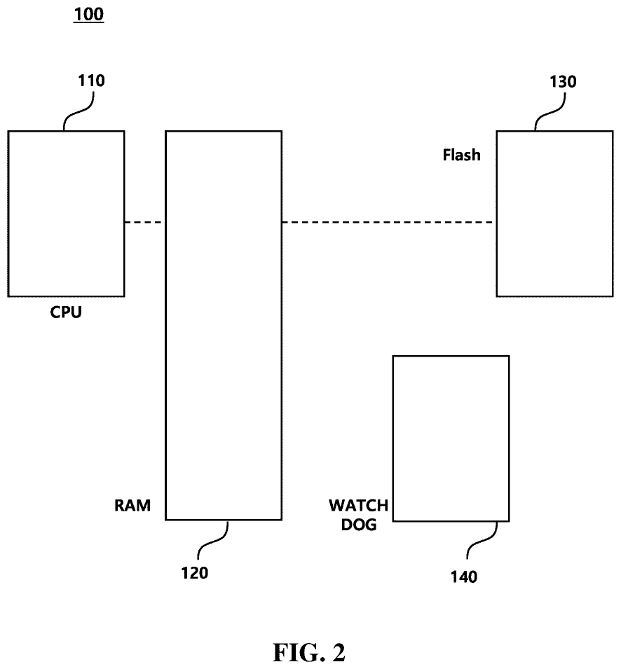

FIG. 2 is a configuration diagram of an MCU according to an embodiment.

Referring to FIG. 2, the MCU 100 may comprise a CPU 110, a random access memory (RAM) 120, a flash memory 130, and a watchdog circuit 140.

The CPU 110 may execute commands of a program, drafted in a machine language, sequentially or in parallel. The CPU 110 may also comprise an arithmetic logic unit (ALU) to perform arithmetic and logical operations and control the order and timing for operations and executions of commands.

The CPU 110 may comprise registers, an ALU, a control device, and a bus system. A register may store data and intermediate operation results. The ALU may perform arithmetic and logical operations. The control device may control interpretations and executions of commands. The bus system may provide a passage through which data, addresses, and control signals are transmitted and received.

The CPU 110 may control operations in the MCU 100. Hereinafter, works of the MCU 100 may be understood as works of the CPU 110.

The RAM 120, which is a temporary storage space of data, may be used for temporarily storing or loading data while a program is executed in the MCU. A RAM 120 is where data is rapidly read and written and, when power is off, all stored data may disappear.

The RAM 120 may store data, such as variables, intermediate operation results, arrays of a program that the MCU 100 executes. Such data may be changed while the program is executed.

The RAM 120 may perform stack storage. The MCU 100 may use stacks for function calls, interrupt processing, or the like. In a stack, function return addresses, local variables, states of registers of the CPU 110 may be stored.

In the RAM 120, a boot manager may be loaded and executed. The boot manager may be a software component that plays an important role in initializing a system and loading an application. The boot manager may be loaded in the RAM 120 at a start point of a system to be executed.

The boot manager may be a code that is firstly executed when the MCU 100 is supplied with power or after the MCU 100 has been reset. In this case, the boot manager may initialize basic hardware of a system.

Although the boot manager is stored in the flash memory 130, it may be loaded in the RAM 120 to be executed. The boot manager loaded in the RAM 120 may perform a function of calling an application stored in the flash memory 130 after having completed the initialization of the system.

The boot manager may perform an important function when updating or rolling back an application. The boot manager may receive an image of new firmware and store it in the flash memory so as to control an application according to the image of new firmware to be loaded. After being loaded in the RAM 120, the boot manager may update or roll back an application. In this way, the updating or roll-back is possible in a flash memory 130 with a single partition as well.

The watchdog circuit 140 may comprise a count timer. When the value of the count timer, that performs countdown, reaches 0, the watchdog circuit 140 may determine that the system has problems and may automatically reset the MCU 100, generate an interrupt indicating an error, or perform other recovery operations. The MCU 100 may periodically reset the count timer so that the value of the count timer does not reach 0. Such an operation may be referred to as ‘kick’ or ‘feeding’. When an abnormality occurs in the MCU 100 and the normal ‘kick’ code is not executed, the count timer may count down to 0 and perform a recovery operation.

The flash memory 130 is a non-volatile storage medium of which contents are not erased even when power is off.

The flash memory 130 may be used as a storage for main programs of the MCU 100. In the flash memory 130 embedded in the MCU 100, source codes, converted into machine codes or binary codes, may be stored.

In the flash memory 130, data may be re-written or deleted multiple times within a predetermined of times. Such a characteristic may be very useful for system updating or application upgrading.

The flash memory 130 may store the boot manager. The boot manager is executed initially when the MCU boots up and may assist the MCU 100 to upload new codes in the flash memory 130 when an application is required to be changed.

The flash memory 130 may comprise a single partition. In this partition, the occurrence of Read-While-Write (RWW) may be prohibited.

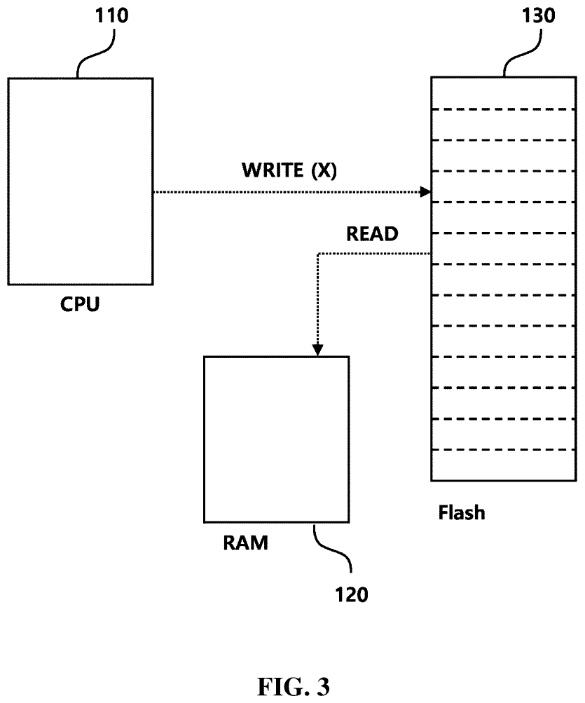

FIG. 3 is a diagram illustrating that occurrence of RWW in a flash memory is prohibited.

Referring to FIG. 3, in the flash memory 130, writing may be prohibited while reading is performed.

When storing data, the flash memory stores data by trapping charges in cells. Such a storage method is very efficient when reading or writing data, but may not support an operation of writing data in one area while reading data in another area.

The CPU 110 may directly execute codes in the flash memory 130. In such a case, if the CPU 110 tries to update an area of codes currently in execution of the flash memory 130, an access to this area may be temporarily stopped. This may cause a problem in operations of the system.

According to an embodiment, in order to prevent such an RWW occurrence, the boot manager may be loaded and executed in the RAM 120 when the updating or roll-back is performed. In addition, in order to perform the updating or roll-back in the flash memory 130 with a single partition, interrupt locking or unlocking may be performed.

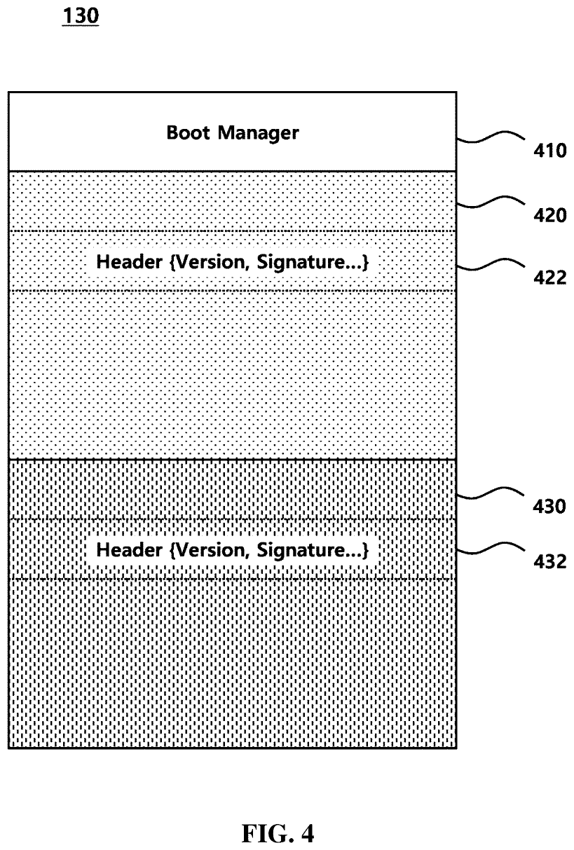

FIG. 4 is a diagram illustrating area divisions of a flash memory according to an embodiment.

Referring to FIG. 4, the flash memory 130, which comprises a single partition, may comprise a first memory area 410, a second memory area 420, and a third memory area 430.

The first memory area 410 may store the boot manager, the second memory area 420 may store a first application, and the third memory area 430 may store a second application. Here, an application may be understood as a program or a set of program codes in terms of form. Otherwise, an application may be understood as a series of operations or functions formed by executions of such a program or program codes.

The first application may be in execution and to be replaced and the second application may be an application to replace the first application. If the second application is a higher version than the first application, it may be understood that the first application is updated or upgraded to the second application, and if the second application is a lower version than the first application, it may be understood that the first application is rolled back to the second application.

When the system boots up, the boot manager stored in the first memory area 410 may be loaded in the RAM to initialize the system. After initializing the system, the boot manager may execute one of the first application and the second application.

The boot manager may verify headers 422, 432 in the first application and the second application or in the second memory area 420 and the third memory area 430, and identify a higher priority value in the headers to execute one of the first application and the second application.

For example, if a higher priority value is recorded in the first application, the boot manager may activate the first application when the system boots up and, if a higher priority value is recorded in the second application, the boot manager may activate the second application when the system boots up.

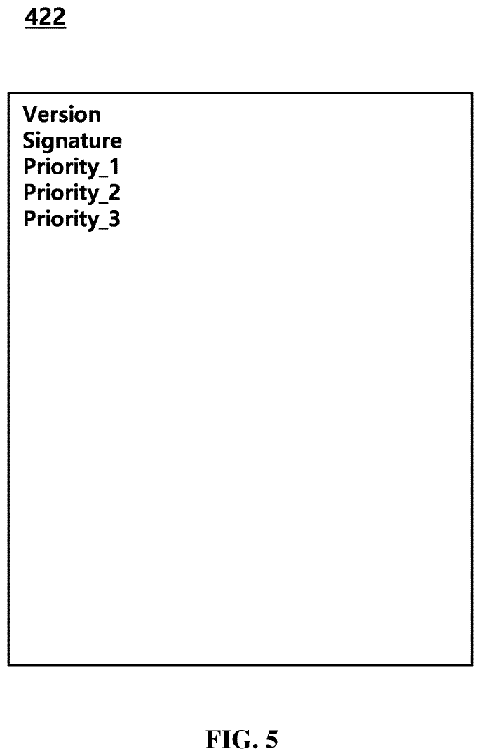

FIG. 5 is a configuration diagram of a header of a first application according to an embodiment.

Referring to FIG. 5, in the header 422, a version value, a signature, and a plurality of priority values Priority_1, Priority_2, Priority_3 may be recorded.

A version of an application may be recorded as the version value. The version value may be determined by a person who drafts codes of an application.

A signature may be an encrypted value for verifying the authenticity and integrity of a firmware image for an application. A signature may be included in the header 422 for the purpose of verification of a manufacturer or source of firmware and verification that the firmware is not damaged during the transmission/reception and the firmware is not modified by external malicious attacks.

A signature may be generated by generating a hash value for a firmware image and encrypting the hash value using a secret key. Here, only a manufacturer of the firmware may have the secret key. When the firmware is downloaded to the flash memory, the hash value is decrypted using a previously verified secret key and a hash value is calculated using the same hash algorithm. When the decrypted hash value is identical to the calculated hash value, the firmware may be determined to be intact.

In predetermined locations of the header 422, a plurality of priority values Priority_1, Priority_2, Priority_3 may be recorded. The plurality of priority values Priority_1, Priority_2, Priority_3 may be invalid or initialized to be certain values. The MCU may record a priority value in one variable among the plurality of priority values Priority_1, Priority_2, Priority_3 and may read such priority values when booting up the system to determine which application is executed.

Each variable, in which each of the plurality of priority values Priority_1, Priority_2, Priority_3 is stored, may have a memory size smaller than or equal to the size of a page unit. The MCU may write in the flash memory by page unit. Although the memory size of a page may differ depending on products or manufacturers, it may generally be from hundreds of bytes to some kilobytes. In a flash memory, writing may be performed only in blank pages. If a page is already filled with data, the relevant block may need to be erased before performing re-writing in that page.

The MCU according to an embodiment may store variables respectively to store the plurality of priority values Priority_1, Priority_2, Priority_3 in different pages and may sequentially record priority values in variables where priority values have not been recorded.

Since data in the flash memory should be erased by block, if existing priority values need to be deleted from the flash memory for writing new priority values, too many areas of data should be deleted. For this reason, the MCU according to an embodiment may record, without deleting operations, priority values sequentially in variables where priority values have not been recorded.

The MCU may scan the variables of the plurality of priority values and determine the highest priority value as the priority value of the relevant application. The MCU may determine priority values for a plurality of applications in this way and activate an application with the highest priority value when the system boots up. When a priority value is determined to be invalid, the MCU may activate another application.

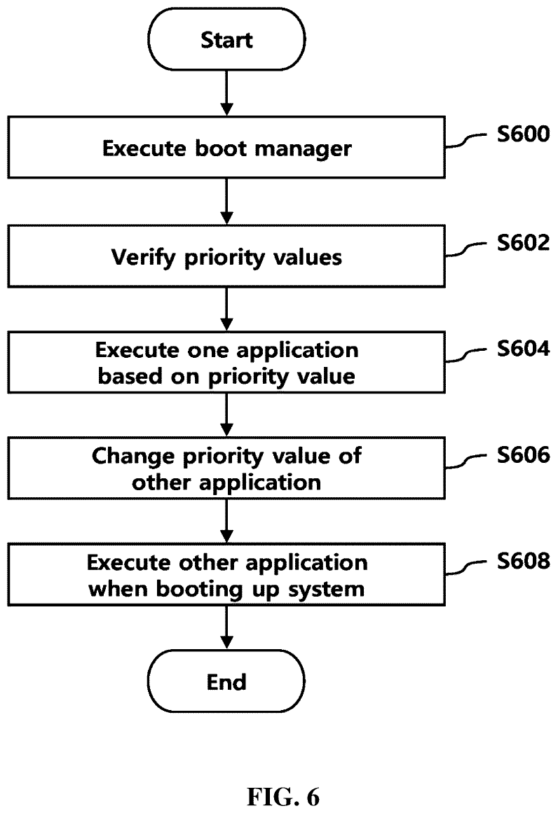

FIG. 6 is a flow diagram illustrating a method of activating applications based on priority values by an MCU according to an embodiment.

Referring to FIG. 6, the MCU may load and execute the boot manager located in the first memory area of the flash memory having a single partition in an operation or step S600.

The MCU may also verify, by the boot manager, priority values in predetermined locations of the first application in the second memory area and the second application in the third memory area of the flash memory in an operation or step S602.

The location of each memory area may be previously determined and the location in each memory for storing a priority value may also be previously determined. The boot manager may verify a plurality of priority values in predetermined locations in this way and determine the highest priority value as the priority value for the relevant application.

The MCU may compare, by the boot manager, the priority value of the first application and the priority value of the second application and activate an application having a higher priority value in an operation or step S604.

While the first application is executed in this way, the MCU may change the priority value of the second application in an operation or step S606. For example, the MCU may change the priority value of the second application to be higher than the priority value of the first application.

When booting up the system, the MCU may perform the aforementioned verification of priority values and execute the second application having a higher priority value in an operation or step S608.

Before changing the priority value of the second application to be higher, the MCU may download a new second application in the third memory area and re-program the second application. In this way, the MCU may be re-programmed through the aforementioned processes.

Before changing the priority value of the second application to be higher, the MCU may receive a request for a roll-back from an external or internal device. In this way, the MCU may have an application, updated or to be updated, rolled back to the second application through the aforementioned processes.

In this way, the MCU according to an embodiment may re-program or roll back an application using the priority values recorded in the headers of the applications.

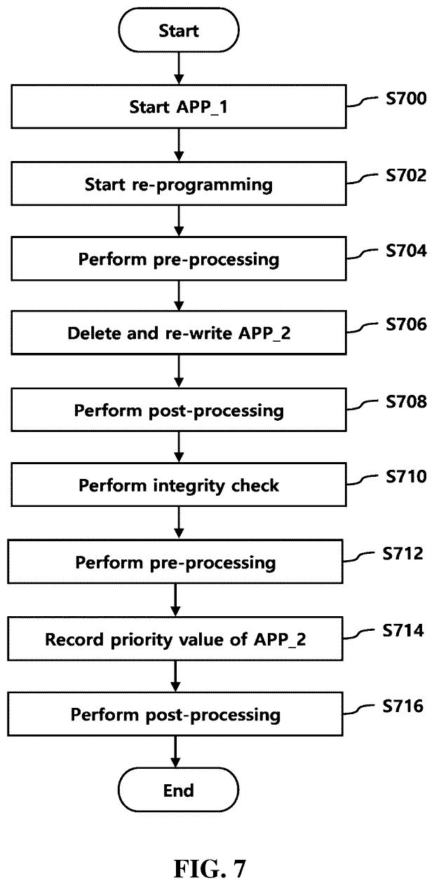

FIG. 7 is a flow diagram illustrating a method of reprogramming applications by an MCU according to an embodiment.

Referring to FIG. 7, the first application may be executed in an operation or step S700.

While the first application is executed, a re-programming process may be started in an operation or step S702.

When the MCU re-programs the second application while executing codes of the first application, a pre-processing and a post-processing may be performed in order to prevent the occurrence of RWW in the flash memory.

The MCU may perform a pre-processing in an operation or step S704 before performing a re-programming of the second application in which the second application is deleted and re-written in an operation or step S706.

In the operation or step S704 of the pre-processing, the MCU may transmit a specific signal to a superior application. Such a specific signal may indicate that the MCU performs a re-programming and is difficult to normally perform a specific operation. While performing the re-programming, the MCU may not process interrupts. If a superior application transmits a command at this moment, the MCU may not normally respond to the command. The MCU may prevent a failure of the entire system by previously notifying such a situation to the superior application using a specific signal.

In the operation or step S704 of the pre-processing, the MCU may inactivate the watchdog circuit. While the watchdog circuit is activated and the count timer of the watchdog circuit keeps performing the countdown, if the MCU cannot complete the re-programming, a system reset may occur by the watchdog circuit. In order to prevent such a problem, the MCU may inactivate the watchdog circuit.

In the operation or step S704 of the pre-processing, the MCU may lock interrupts. When interrupts occur while the MCU writes the second application in the third memory area of the flash memory having a single partition, the MCU tries to read codes of the first application in the second memory area. In this case, the RWW occurs, which leads to a system error. A specific signal transmitted to a superior application may indicate that such interrupts are locked.

After the operation or step S704 of the pre-processing, the MCU may delete and re-write the second application in the flash memory in an operation or step S706.

After having completed the re-programming of the second application, the MCU may perform a post-processing in an operation or step S708.

In the operation or step S708 of the post-processing, the MCU may transmit another specific signal to a superior application to notify that the situation regarding the previous specific signal has been completed.

In the operation or step S708 of the post-processing, the MCU may re-activate the watchdog circuit and unlock interrupts.

The MCU may conduct an integrity check for the second application in an operation or step S710. When the second application is determined to be normal in this integrity check, the MCU may record a higher priority value in the second application than that for the first application in an operation or step S714.

Before recording the priority values, the MCU may further perform the pre-processing in an operation or step S712, and after recording the priority values, the MCU may further perform the post-processing in an operation or step S716. The operation or step of the pre-processing S712 may correspond to the operation or step of the pre-processing S704 before the re-programming and the operation or step of the post-processing S716 may correspond to the operation or step of the post-processing S708 after the re-programming.

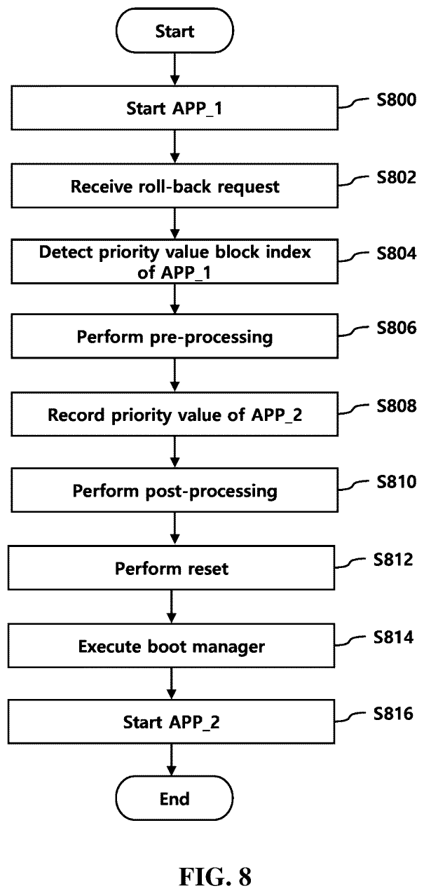

FIG. 8 is a flow diagram illustrating a method of rolling back an application by an MCU according to an embodiment.

Referring to FIG. 8, the first application may be executed in an operation or step S800.

While the first application is executed, a roll-back may be requested in an operation or step S802.

The MCU may detect a priority value block index of the first application and verify the priority value of the first application in an operation or step S804.

The MCU may record, in the second application, a priority value higher than the priority value of the first application in an operation or step S808.

Before recording the higher priority value in the second application in the operation or step S808, the MCU may further perform the pre-processing in an operation or step S806, and after recording the priority value, the MCU may further perform the post-processing in an operation or step S810.

In the operation or step S806 of the pre-processing, the MCU may transmit a specific signal to a superior application. Such a specific signal may indicate that the MCU performs the re-programming and is difficult to normally perform a specific operation. While performing the re-programming, the MCU may not process interrupts. When a superior application transmits a command at this moment, the MCU may not normally respond to the command. The MCU may prevent a failure of the entire system by previously notifying such a situation to the superior application using a specific signal.

In the operation or step S806 of the pre-processing, the MCU may inactivate the watchdog circuit. While the watchdog circuit is activated and the count timer of the watchdog circuit keeps performing the countdown, if the MCU cannot complete the re-programming, a system reset may occur by the watchdog circuit. In order to prevent such a problem, the MCU may inactivate the watchdog circuit.

In the operation or step S806 of the pre-processing, the MCU may lock interrupts. When interrupts occur while the MCU writes the second application in the third memory area of the flash memory having a single partition, the MCU tries to read codes of the first application in the second memory area. In this case, the RWW occurs, which leads to a system error. A specific signal transmitted to a superior application may indicate that such interrupts are locked.

After the operation or step S806 of the pre-processing, the MCU may record a higher priority value in the second application than that for the first application in the flash memory in an operation or step S808.

In an operation or step S810 of the post-processing, the MCU may transmit another specific signal to a superior application to notify that the situation regarding the previous specific signal has been completed.

In the operation or step S810 of the post-processing, the MCU may re-activate the watchdog circuit and unlock interrupts.

After changing the priority values, the MCU may perform a reset in an operation or step S812. When the boot manager is re-executed by the reset in an operation or step S814, the roll-back may be performed by executing the second application having a higher priority value in an operation or step S816.

As described above, according to embodiments of the present disclosure, an application may be updated using a flash memory with a single partition and an application, which has been updated or is being updated, may be rolled back using a flash memory with a single partition.

Since terms, such as “including,” “comprising,” and “having” mean that corresponding elements may exist unless they are specifically described to the contrary, it should be construed that other elements can be additionally included, rather than that such elements are excluded. All technical, scientific, or other terms are used consistently with the meanings as understood by a person skilled in the art unless defined to the contrary. Common terms as found in dictionaries should be interpreted in the context of the related technical writings, rather than overly ideally or impractically, unless the present disclosure expressly defines them so.

Although example embodiments of the present disclosure have been described for illustrative purposes, those having ordinary skill in the art should appreciate that various modifications, additions, and substitutions are possible without departing from the scope and spirit of the present disclosure. Therefore, the embodiments described in the present disclosure are intended to illustrate the scope of the technical idea of the present disclosure, and the scope of the present disclosure is not limited by the described embodiments. The scope of the present disclosure should be construed on the basis of the accompanying claims in such a manner that all of the technical ideas included within the scope equivalent to the claims are included in the present disclosure.

What is claimed is:

1. A microcontroller unit (MCU), the MCU comprising:
a flash memory with a single partition comprising a first memory area for a boot manager, a second memory area for a first application, and a third memory area for a second application;
a random access memory (RAM) where the boot manager is loaded; and
a central processing unit (CPU) to lock interrupts for preventing an occurrence of Read-While-Write (RWW) for the flash memory when performing a re-programming for the second application while executing codes of the first application, to unlock the interrupts after the re-programming has been completed, and to cause the boot manager to activate the second application having a higher priority value when the MCU boots up, by recoding the higher priority value for the second application.

2. The MCU of claim 1, wherein the CPU is configured to lock the interrupts for preventing the occurrence of the RWW before the recording the higher priority value for the second application.

3. The MCU of claim 1, wherein the CPU is configured to conduct an integrity check for the second application, for which the re-programming has been completed, before the recording the higher priority value for the second application and, when the second application is determined to be normal in the integrity check, to record the higher priority value for the second application.

4. The MCU of claim 1, wherein, when locking the interrupts, the CPU is configured to transmit, to a superior application through communication, a signal indicating that the interrupts are locked.

5. The MCU of claim 1, wherein, when locking the interrupts, the CPU is configured to inactivate a watchdog function.

6. The MCU of claim 1, wherein the CPU is configured to read priority values in predetermined locations of the first application and the second application and to compare the priority values to activate one of the first application and the second application which has a higher priority value.

7. The MCU of claim 6, wherein, when the priority value of the one of the first application and the second application is determined to be invalid, the CPU is configured to activate the other application.

8. The MCU of claim 1, wherein priority values are recorded in variables, each of the priority values having a size smaller than or equal to a size of a page unit in each of the first application and the second application.

9. The MCU of claim 1, wherein each of the first application and the second application is configured to store a plurality of priority value variables, and wherein the CPU is configured to sequentially record the plurality of priority values in variables where the plurality of priority values has not been recorded.

10. The MCU of claim 9, wherein the CPU is configured to scan the plurality of priority value variables and to determine a highest priority value as a priority value of a corresponding one of the first application the second application.

11. A microcontroller unit (MCU), the MCU comprising:
a flash memory with a single partition comprising a first memory area for a boot manager, a second memory area for a first application, and a third memory area for a second application;
a random access memory (RAM) where the boot manager is loaded; and
a central processing unit (CPU) to verify a priority value for the first application when a roll-back to the second application is requested while executing codes of the first application, to lock interrupts for preventing an occurrence of Read-While-Write (RWW) for the flash memory, to record a priority value for the second application to be higher than the priority value for the first application, to unlock the interrupts, and to cause the boot manager to activate the second application having a higher priority value when the MCU boots up.

12. The MCU of claim 11, wherein the flash memory is configured to be erased by block and be written by page, and wherein a priority value of each of the first application and the second application has a size smaller than or equal to a size of a page unit.

13. The MCU of claim 11, wherein each of the first application and the second application is configured to store a plurality of priority value variables, and wherein the CPU is configured to sequentially record the plurality of priority values in variables where the plurality of priority values has not been recorded.

14. The MCU of claim 13, wherein the CPU is configured to scan the plurality of priority value variables and to determine a highest priority value as a priority value of a corresponding one of the first application and the second application.

15. The MCU of claim 11, wherein, when locking the interrupts, the CPU is configured to transmit, to a superior application through communication, a signal indicating that the interrupts are locked.

16. The MCU of claim 11, wherein, when locking the interrupts, the CPU is configured to inactivate a watchdog function.

17. A method for changing applications in a microcontroller unit (MCU), the method including operations or steps of:
loading a boot manager located in a first memory area of a flash memory with a single partition to execute the boot manager;
verifying, by the boot manager, priority values in predetermined locations of a first application in a second memory area of the flash memory and a second application in a third memory area of the flash memory;
comparing, by the boot manager, a priority value of the first application and a priority value of the second application to activate one of the first application and the second application having a higher priority value;
locking interrupts for preventing an occurrence of Read-While-Write (RWW) for the flash memory while the first application is executed and unlocking the interrupts after having recorded the priority value of the second application to be higher than the priority value of the first application; and
activating, by the boot manager, the second application having the higher priority value when the MCU boots up.

18. The method of claim 17, further comprising an operation or step of locking the interrupts before the priority value of the second application is recorded to be higher, and subsequently unlocking the interrupts after a re-programming for the second application has been completed.

19. The method of claim 17, further comprising an operation or step of requesting a roll-back to the second application before the priority value of the second application is recorded to be higher.

20. A non-transitory computer-readable medium, comprising a set of instructions stored thereon, that when executed by a processor, perform a method comprising:
loading a boot manager located in a first memory area of a flash memory with a single partition to execute the boot manager;
verifying priority values in predetermined locations of a first application in a second memory area of the flash memory and a second application in a third memory area of the flash memory;
comparing a priority value of the first application and a priority value of the second application to activate one of the first application and the second application having a higher priority value;
locking interrupts for preventing an occurrence of Read-While-Write (RWW) for the flash memory while the first application is executed and unlocking the interrupts after having recorded the priority value of the second application to be higher than the priority value of the first application; and
activating the second application having the higher priority value when a system boots up.
